(19) United States
(12) Patent Application Publication
(10) Pub. No.: US 2026/0070735 A1
(43) Pub. Date: Mar. 12, 2026

(54) AN AUTOMATED STORAGE AND RETRIEVAL SYSTEM, A CONTAINER TRANSFER APPARATUS AND A METHOD THEREOF

(71) Applicant: AutoStore Technology AS, Nedre Vats (NO)

(72) Inventors: Trond Austrheim, Etne (NO); Ole Andreas Haddeland, Avaldsnes (NO)

(21) Appl. No.: 19/107,682

(22) PCT Filed: Sep. 22, 2023
(86) PCT No.: PCT/EP2023/076255

§ 371 Date: Feb. 28, 2025

(30) Foreign Application Priority Data
Sep. 29, 2022 (NO) 20221038

(51) Int. Cl. B65G 1/04; F25D 13/04; F25D 23/02

(52) U.S. Cl. CPC B65G 1/0464; F25D 13/04; F25D 23/028

(57) ABSTRACT

The invention concerns an automated storage and retrieval system comprising a first space, a second space, a dividing wall, a storage volume to store storage containers in vertical stacks and a horizontal rail system arranged above where the storage containers would be stored. The invention also concerns a container transfer housing configured to allow transfer of the storage containers between the first space and the second space and a method using such a container transfer housing.

### TECHNICAL FILD

The present invention relates to an automated storage and retrieval system, a container transfer apparatus for use in the system and a method for transport of storage containers using the container transfer apparatus.

### BACKGROUND AND PRIOR ART

FIG. 1 discloses a prior art automated storage and retrieval system 1 with a framework structure 100 and FIGS. 2, 3 and 4 disclose three different prior art container handling devices 200,300,400 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 200,300,400 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 200,300,400 in a first direction X across the top of the frame structure 100, and a second set of parallel rails 111 arranged perpendicular to the first set of rails 110 to guide movement of the container handling vehicles 200,300,400 in a second direction Y which is perpendicular to the first direction X. Containers 106 stored in the columns 105 are accessed by the container handling vehicles 200,300,400 through access openings 112 in the rail system 108. The container handling vehicles 200,300,400 can move laterally above the storage columns 105, i.e. in a plane which is parallel to the horizontal X-Y plane.

The upright members 102 of the framework structure 100 may be used to guide the containers 106 during raising of the containers 106 out from and lowering of the containers 106 into the columns 105. The stacks 107 of containers 106 are typically self-supporting.

Each prior art container handling device 200,300,400 comprises a handling device body/vehicle body 201,301,401 and first and second sets of wheels 202a,202b,302a,302b,402a,402b which enable the lateral movement of the container handling devices 200,300,400 in the X direction and in the Y direction, respectively. In FIGS. 2, 3 and 4 two wheels in each set are fully visible. The first set of wheels 202a,302a,402a is arranged to engage with two adjacent rails of the first set 110 of rails, and the second set of wheels 202b,302b,402b is arranged to engage with two adjacent rails of the second set 111 of rails. At least one of the sets of wheels 202a, 202b, 302a,302b,402a,402b can be lifted and lowered, so that the first set of wheels 202a,302a,402a and/or the second set of wheels 202b,302b,402b can be engaged with the respective set of rails 110, 111 at any one time.

Each prior art container handling device 200,300,400 also comprises a lifting device 303,403 for vertical transportation of containers 106, e.g. raising a container 106 from, and lowering a container 106 into, a storage column 105. The lifting device 303,403 comprises one or more gripping/engaging devices 404 which are adapted to engage a container 106, and which gripping/engaging devices 404 can be lowered from the vehicle 200,300,400 so that the position of the gripping/engaging devices 404 with respect to the vehicle 200,300,400 can be adjusted in a third direction Z which is orthogonal the first direction X and the second direction Y. The gripping device 404 of the container handling device/vehicle 400 in form of a plurality of claws is shown in FIG. 4. The lifting device of the container handling device 200 is located within the vehicle body 201 and is thus not shown.

Conventionally, and also for the purpose of this application, Z=1 identifies the uppermost layer available for containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of containers. Similarly, X=1 . . . n and Y=1 . . . n identifies the position of each storage column 105 in the horizontal plane. Consequently, as an example, and using the Cartesian coordinate system X, Y, Z indicated in FIG. 1, the containers identified as 106′ in FIG. 1 can be said to occupy storage position X=17, Y=1, Z=6. The container handling devices 200,300,400 can be said to travel in layer Z=0, and each storage column 105 can be identified by its X and Y coordinates. Thus, the containers shown in FIG. 1 extending above the rail system 108 are also said to be arranged in layer Z=0.

The storage volume 104 of the framework structure 100 has often been referred to as a storage grid, where the possible storage positions within this grid are referred to as storage cells. Each storage column may be identified by a position in an X- and Y-direction, while each storage cell may be identified by a container number in the X-, Y- and Z-direction.

Each prior art container handling device 200,300,400 comprises a storage compartment or space for receiving and stowing a container 106 when transporting the container 106 across the rail system 108. The storage space may comprise a cavity arranged internally within the vehicle body 201,301,401 as present in FIGS. 2 and 4 and as described in e.g. WO2015/193278A1 and WO2019/206487A1, the contents of which are incorporated herein by reference.

FIG. 3 shows an alternative configuration of a container handling device/vehicle 300 with a cantilever construction. Such a vehicle is described in detail in e.g. NO317366, the contents of which are also incorporated herein by reference.

The central cavity type vehicle 200 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling devices/vehicle 400 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where containers 106 are stored in stacks 107. However, some columns may have other purposes. In FIG. 1, columns 119 and 120 are such special-purpose columns used by the container handling devices 200,300,400 to drop off and/or pick up containers 106 so that they can be transported to an access station (not shown) where the containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the containers 106 may be placed in a random or dedicated column 105 within the framework structure 100, then picked up by any container handling device and transported to a port column 119,120 for further transportation to an access station. The transportation from the port to the access station may require movement along various different directions, by means such as delivery vehicles, trolleys or other transportation lines. Note that the term ‘tilted’ means transportation of containers 106 having a general transportation orientation somewhere between horizontal and vertical.

In FIG. 1, the first port column 119 may for example be a drop-off port column where the container handling devices 200,300,400 can drop off containers 106 to be transported to an access or a transfer station, and the second port column 120 may be a dedicated pick-up port column where the container handling devices 200,300,400 can pick up containers 106 that have been transported from an access or a transfer station.

The access station may typically be a picking or a stocking station where product items are removed from or positioned into the containers 106. In a picking or a stocking station, the containers 106 are normally not removed from the automated storage and retrieval system 1, but are returned into the framework structure 100 again once accessed. A port can also be used for transferring containers to another storage facility (e.g. to another framework structure or to another automated storage and retrieval system), to a transport vehicle (e.g. a train or a lorry), or to a production facility.

A conveyor system comprising conveyors is normally employed to transport the containers between the port columns 119,120 and the access station.

If the port columns 119,120 and the access station are located at different levels, the conveyor system may comprise a lift device with a vertical component for transporting the containers 106 vertically between the port column 119,120 and the access station.

The conveyor system may be arranged to transfer containers 106 between different framework structures, e.g. as is described in WO2014/075937A1, the contents of which are incorporated herein by reference.

When a container 106 stored in one of the storage columns 105 disclosed in FIG. 1 is to be accessed, one of the container handling devices 200,300,400 is instructed to retrieve the target container 106 from its position and transport it to the drop-off port column 119. This operation involves moving the container handling device 200,300,400 to a location above the storage column 105 in which the target container 106 is positioned, retrieving the container 106 from the storage column 105 using the container handling device's 200,300,400 lifting device, and transporting the container 106 to the drop-off port column 119. If the target container 106 is located deep within a stack 107, i.e. with one or a plurality of other containers 106 positioned above the target container 106, the operation also involves temporarily moving the above-positioned containers prior to lifting the target container 106 from the storage column 105. This step, which is sometimes referred to as “digging” within the art, may be performed with the same container handling device that is subsequently used for transporting the target container to the drop-off port column 119, or with one or a plurality of other cooperating container handling devices. Alternatively, or in addition, the automated storage and retrieval system 1 may have container handling devices 200,300,400 specifically dedicated to the task of temporarily removing containers 106 from a storage column 105. Once the target container 106 has been removed from the storage column 105, the temporarily removed containers 106 can be repositioned into the original storage column 105. However, the removed containers 106 may alternatively be relocated to other storage columns 105.

When a container 106 is to be stored in one of the columns 105, one of the container handling devices 200,300,400 is instructed to pick up the container 106 from the pick-up port column 120 and transport it to a location above the storage column 105 where it is to be stored. After any containers 106 positioned at or above the target position within the stack 107 have been removed, the container handling device 200,300,400 positions the container 106 at the desired position. The removed containers 106 may then be lowered back into the storage column 105, or relocated to other storage columns 105.

For monitoring and controlling the automated storage and retrieval system 1, e.g. monitoring and controlling the location of respective containers 106 within the framework structure 100, the content of each container 106; and the movement of the container handling devices 200,300,400 so that a desired container 106 can be delivered to the desired location at the desired time without the container handling devices 200,300,400 colliding with each other, the automated storage and retrieval system 1 comprises a control system 700 which typically is computerized and which typically comprises a database for keeping track of the containers 106.

Automated storage and retrieval systems as described above are typically constructed to be operated in areas at ambient temperatures, e.g. about 20° C. However, for some type of products optimal storage temperature may be different. For example, it may be desirable to store food at fridge temperature, typically between 1-4° C., or at freezer temperature, typically below −18° C. or below −20° C.

Furthermore, there may be situations to surround an automated storage and retrieval system with an atmosphere different from the ambient atmosphere, for example to reduce the risk of fire ignition by reducing the oxygen concentration in the surrounding atmosphere.

Automatic storage and retrieval systems having different temperature zones, and where the temperature can be controlled, are known. For example, patent publication WO 2015/124610 A1 describes a system for receiving and storing processed refrigerated and frozen food products using a plurality of container handling vehicles operated on a rail system. In this prior art solution, the containers are stacked below a common rail system in two different storage volumes separated by a wall. The container handling vehicles are allowed to move freely above the two storage volumes at a higher operating temperature such as room-temperature.

One disadvantage of this prior art solution is that a container handling vehicle is exposed to colder temperatures when a container at the colder zone is stored or retrieved. This may result in formation of condensation, potentially causing problems with electronics.

The prior art storage system described in WO 2019/001816 A1 shows a system with different temperature zones and means for transporting containers between the different temperature zones. In order to reduce temporary exposure of the container handling vehicles to cold air, the solution comprises an elevator allowing lowering and raising of containers between an access point to a transfer zone.

However, this solution is complex and costly.

A storage facility where the oxygen concentration may be reduced in order to prevent start of fire is described in the article “WagnerImpulse” in the magazine “The Wagner Group Customer magazine” (3/2018). The low oxygen concentration is obtained by forcing oxygen-reduced air into the entire storage facility.

The article does not present any solutions for maintaining such a low oxygen concentration over a longer time-frame, such as several days. For example, the article gives no indication of how the storage system may be operated to transport containers in or out of the storage system without increasing the oxygen concentration. Such an operation would necessitate frequent exposure of the storage system to atmospheric air.

It is an aim of the present invention to provide an automated storage and retrieval system and a method for operating such a system that solves or at least mitigates one or more of the aforementioned problems related to the use of prior art storage and retrieval systems.

It is also an aim of the present invention to provide solutions that allows handling of containers within a storage system located in a space having an environment different to the surrounding environment.

It is further an aim of the present invention to provide solutions that minimize restructuring of prior art systems as shown in FIGS. 1-4.

### SUMMARY OF THE INVENTION

The present invention is set forth and characterized in the independent claims, while the dependent claims describe other preferred/optional features.

In a first aspect, the invention concerns an automated storage and retrieval system comprising a first space, a second space, a first storage volume within the first space to store storage containers in vertical stacks and a horizontal rail system arranged above where the storage containers are stored or would be stored. The rail system comprises a first set of rails and a second set of rails oriented perpendicular to the first set of rails, the intersections of which rails form a grid of grid cells defining grid openings.

‘Storage containers’ is herein defined as any form of goods holder that can be arranged in vertical stacks. Hence, storage containers include, but is not limited to, a rectangular box with four complete sides and a base. The storage container may e.g. also comprise a box having one or more holes or cutaway regions in any of the side or base surfaces.

The system also comprises a first container handling vehicle configured to lift a storage container through one of the grid openings and to transport the storage container along the rail system, a wall dividing the first space and the second space, and a container transfer housing configured to provide a passage to allow transfer of the storage containers between the first space and the second space. The wall comprises an opening having a size allowing at least the storage containers to pass through the wall and preferably a size allowing the entire first container handling vehicle to pass through.

The housing and the wall's opening may advantageously be configured such that the storage container is allowed to be transferred from one space to the other without exposing the first container handling vehicle to significant changes in temperature and/or loss of special atmosphere.

Also, the container transfer housing may be arranged such that a lower part is flush with an upper part of the horizontal rail system.

If the container transfer housing is arranged at least partly within the first space, and/or if the rail system extends into the second space (see below), the container transfer housing may be positioned on top of the rail system.

In an exemplary configuration, the container transfer housing may be arranged adjacent the opening. Alternatively, the container transfer housing may be arranged within the opening.

In an exemplary configuration the container transfer housing may comprise a first door configured to open and close a first access point of the container transfer housing and a second door configured to open and close a second access point of the container transfer housing.

For this exemplary configuration the automated storage and retrieval system may also comprise a door mechanism configured to operate the first and/or the second doors such that one door is closed when the other door is opened. Moreover, the container transfer housing may be designed and positioned such that, when one of the first door and the second door is closed, the opening in the wall is also closed. The door mechanism may also be mounted on other parts of the automated storage and retrieval system, for example on the wall. The second door may be positioned/arranged to simultaneously open and close one side of the opening.

Alternatively or in addition, the door mechanism may be configured to operate the first and the second doors such that both doors may be in an opened or closed position. Both doors may thus be kept open during normal operation to allow transport of containers/container handling vehicles between the spaces and be kept closed under extraordinary conditions such as fire and/or smoke development in one of the spaces. The system may thus act as an effective douser/fire damper.

To allow both doors to be closed also allows for other operations such as ventilating one of the spaces.

Alternatively or in addition to the second door, the automated storage and retrieval system may comprise a wall mounted door. Similar to the configuration with the first and second doors, the door mechanism may be configured to operate the first door and/or the wall mounted door such that one door is closed when the other door is opened. Also, the container transfer housing may be designed and positioned such that, when one of the first door and the wall mounted door is closed, the opening is also closed.

In an exemplary configuration the door mechanism may comprise a drive shaft motor configured to lift the first door relative to the first access point. The direction of the lifting is preferably vertical relative to the rail system in order to minimize space. The design of the doors is also not affected by the rails when the lift is performed vertically.

In an exemplary configuration the door mechanism may comprise a first drive shaft and a first wire connecting the first drive shaft to the first door, wherein the drive shaft motor is configured to rotate the first drive shaft, thereby lifting the first door. Herein, ‘wire’ may be defined broadly as any structure capable of being wound around a shaft and used to lift and lower the first door.

In an exemplary configuration the first drive shaft, the first wire and the drive shaft motor may be configured such that, when the drive shaft motor is rotating the first drive shaft in one rotational direction, the first door is lowered to close the first access point and when the drive shaft motor is rotating the first drive shaft in the opposite rotational direction, the first door is raised to open the first access point.

In an exemplary configuration the door mechanism may comprise a second wire connecting the first drive shaft to the second door (preferably via a second drive shaft) such that, when the drive shaft motor is rotating the first drive shaft in one rotational direction, the second door is moving in opposite direction of the first door. In this way the second door opens when the first door closes, and vice versa.

In an exemplary configuration the door mechanism may comprise a second drive shaft motor configured to lift the second door relative to the second access point. Using a second drive shaft motor capable of operating independently of the first drive shaft motor is considered advantageous since the opening of one access point may be performed after the other access point has been fully closed. Hence, the risk of thermal and/or gaseous leakage between the first and second spaces may be reduced.

In an exemplary configuration the door mechanism may comprise a second wire connecting the second drive shaft to the second door such that, when the second drive shaft motor is rotating the second drive shaft in one direction, the second door is lifted relative to the second access point and when the second drive shaft motor is rotating the second drive shaft in the other direction, the second door is lowered relative to the second access point.

In an exemplary configuration the second drive shaft, the second wire and the second drive shaft motor may be configured such that, when the second drive shaft motor is rotating the second drive shaft in one rotational direction, the second door is lowered to close the second access point (and preferably also the opening through the wall), and when the second drive shaft motor is rotating the second drive shaft in the opposite rotational direction the second door is raised to open the second access point (and preferably also the opening through the wall).

In an exemplary configuration the container transfer housing and the door mechanism may constitute parts of a container transfer apparatus removable as a unit from other parts of the automated storage and retrieval system.

In an exemplary configuration the first space may be enclosed by the dividing wall arranged at one side of the first storage volume, a floor arranged below the first storage volume, a roof arranged above the first storage volume, a second wall arranged at a side of the first storage volume distant from the dividing wall, a third wall extending between the second wall and the dividing wall at another side of the first storage volume and a fourth wall extending between the second wall and the dividing wall at a further side of the first storage volume.

In an exemplary configuration the automated storage and retrieval system may comprise a container transporting device arranged in the second space, wherein the container transporting device is configured to transport a storage container from inside the container transfer housing via the second access point and to another location in the second space.

Alternatively, or in addition, a human operator may remove the storage container from inside the container transfer housing and transport the container to another location in the second space.

In an exemplary configuration the storage and retrieval system may comprise a second storage volume contained within the second space to store storage containers in vertical stacks. In this configuration the horizontal rail system may extend through the opening and above the second storage volume such that a vertical height from a top part of the rail system to a top part of the opening is equal or higher than a maximum height of the storage containers to be stored and preferably also higher than a maximum height of the first container handling vehicle.

In an exemplary configuration the container transporting device may be a second container handling vehicle configured to transport a storage container from the container transfer housing along the horizontal rail system. The size of the second access point is preferably large enough to allow the second container handling vehicle to pass through.

The first and/or the second container handling vehicle may be a prior art container handling with a cantilever construction.

In an exemplary configuration an inner volume of the container transfer housing may cover n times m grid openings of the rail system, where n and m are integers.

In an exemplary configuration the container transfer housing may display an open bottom face, i.e. towards the storage volume (when present). The automated storage and retrieval system may further comprise a skirt attached to the container transfer housing and/or the rail system and/or any framework structure below the rail system, wherein the skirt extends around at least partly, for example fully, the open bottom face.

In an exemplary configuration the skirt may extend a distance below the container transfer housing corresponding to at least part of a vertical distance from the open bottom face and a floor below the first storage volume and the second storage volume if present. The skirt preferably extends a vertical distance corresponding to two or more depths of storage cells, for example the full distance to the floor or the full height of a storage column. The latter configuration may be the case if a lowest point of a storage column is raised above a floor of the building, for example to allow cold air to circulate below the stacks of storage columns.

When the container transfer housing is arranged on top of the horizontal rail system covering n times m grid openings, where n and m are integers, the edges of the container transfer housing's lower face may be arranged immediately outside the rails setting up the periphery of the n times m grid opening area of the rail system, thereby allowing maximum degree of freedom of container handling vehicles having entered the housing. The attachment of the container transfer housing may be to the rails and/or to framework structures situated below the rails (see below). If the container transfer housing is configured to allow container handling vehicles to enter, the size of the housing is wider than the grid opening size, thus allowing the wheels of the vehicle entering the housing to couple with the rails. For example, if the rail system comprises double track rails, the container transfer housing may be of a size extending to a halfway point of each rail setting up the n times m grid openings.

In an exemplary configuration the first storage volume and/or the second storage volume (see below) may contain upright members between which the stacks of containers are stored. The upper end of the upright members may be connected to the intersections of the rail system.

In an exemplary configuration the container transfer housing may have an open bottom rectangular face and is arranged within the first space and/or the second space such that the open bottom rectangular face has its principal directions aligned with the orientations of the first and second set of rails.

In an exemplary configuration the skirt may comprise 2 times n X plates and 2 times m Y plates distributed around the circumference of the open bottom rectangular face such that the upright members, the rail system and the skirt establish an enclosed space extending at least partly to the floor above the first storage volume and (if present) the second storage volume, for example a depth of 2 or more storage cells below the rail system. Hence, each X plate may have a width equal to, or near equal to, the size of the grid opening along the first set of rails and each Y plate may have a width equal to, or near equal to, the size of the grid opening along the second set of rails

In an exemplary configuration the storage and retrieval system may comprise a second storage volume within the second space to store storage containers in vertical stacks, wherein the horizontal rail system extends through the opening and above the second storage volume such that a vertical height from a top part of the rail system to a top part of the opening is equal or higher than a maximum vertical height of the storage containers to be stored, and preferably also a maximum vertical of the first container handling vehicle and/or (if present) the second container handling vehicle.

In an exemplary configuration the skirt may be provided with thermally insulating material to reduce thermal conduction across the skirt, i.e. between an inner volume defined by the skirt and an outside environment of the skirt. A reduction in thermal conduction across the skirt results in a reduction in thermal conduction between the first space and the second space.

In an exemplary configuration the automated storage and retrieval system may comprise a cooling unit configured to provide a cooler temperature within the first space than the temperature within the second space.

In an exemplary configuration the dividing wall may be provided with thermal insulation to reduce thermal conduction between the first space and the second space.

In an exemplary configuration a vertical cross section of the second door of the container transfer housing may be larger than a vertical cross section of the opening of the dividing wall.

In an exemplary configuration the container transfer housing may be arranged such that direct contact, or near direct contact, between part of the second door and the wall is established.

In a second aspect, the invention concerns a container transfer apparatus for transfer of storage containers between a first space having a first temperature and/or a first pressure and/or a first atmosphere and a second space having a second temperature and/or a second pressure and/or a second atmosphere different from the first temperature/pressure/gas. The container transfer apparatus comprises a container transfer housing and optionally a skirt attached to the container transfer housing. The skirt may be configured (i.e. design and/or choice of material) such that thermal conduction across the skirt is reduced, for example by more than 50%. ‘Across the skirt’ herein means in a thickness direction between an inner volume defined by the skirt and a surrounding environment of the skirt.

The container transfer housing comprises a first door configured to open and close a first access point of the container transfer housing, a second door configured to open and close a second access point of the container transfer housing and a door mechanism configured to operate the first door and/or the second door such that one door is closed when the other door is opened.

In an exemplary configuration of the second aspect the container transfer housing and the skirt may define an inner volume (preferably of at least 5 sides) and at least part of the container transfer apparatus may be provided with thermal insulating material to reduce thermal conduction from the inner volume to its surroundings.

In an exemplary configuration of the second aspect the container transfer housing may have an open bottom rectangular face of two parallel X sides and two parallel Y sides, wherein the skirt comprises n X plates arranged at each of the two parallel X sides of the bottom rectangular face and m Y plates arranged at each of the two parallel Y sides of the bottom rectangular face, where n and m are integers. The n X plates and the m Y plates may be made of thermal insulating material.

In a third aspect, the invention concerns a method for transferring storage containers between a first space and a second space within an automated storage and retrieval system as described above for the first aspect of the invention.

The method comprises the steps of:
placing a storage container within the container transfer housing using a first container handling vehicle operating within the first space, wherein the storage position of the storage container may be into a storage column covered by the container transfer housing,
removing the storage container from the container transfer housing using a lifting device constituting part of a container transporting device operating within the second space and
optionally lowering the storage container into a second storage volume using the lifting device.

The placement of the storage container within the container transfer housing may be performed by driving a part or the entire first container handling vehicle therein, for example a cantilever section when a prior art cantilever construction is used as container handling vehicle.

In an exemplary method of the third aspect the container transfer housing may comprise a first door configured to open and close a first access point of the container transfer housing and a second door configured to open and close a second access point of the container transfer housing. In this exemplary method, the automated storage and retrieval system also comprises a door mechanism configured to operate the first and/or the second doors such that one door is closed when the other door is opened, wherein the container transfer housing is designed and positioned such that, when one of the first door and the second door is closed, the opening is also closed.

The door mechanism may be mounted on various locations of the storage system such as on or within the container transfer housing, on the wall, on the rail system, below the rail system or a combination thereof.

The exemplary method may also comprise the steps of:
opening the first door using the door mechanism prior to placing the storage container within the container transfer housing and
closing the first door using the door mechanism and
opening the second door using the door mechanism, preferably after the first door is closed,
   wherein closing the first door and opening the second door is performed prior to removing the storage container from the container transfer housing by the container transporting device. The container transporting device may include a robot such as a robot having a multi-joint arm and/or a human operator.

In an exemplary method of the third aspect the storage and retrieval system may also comprise a second storage volume within the second space to store storage containers in vertical stacks. The horizontal rail system extends through the opening and above the second storage volume such that a vertical height from a top part of the rail system to a top part of the opening is equal or higher than a maximum height of the storage containers to be stored.

Further, the container transporting device may be a second container handling vehicle configured to transport the storage containers along the horizontal rail system. The vertical height is preferably equal or higher than the maximum height of the first and second container handling vehicles.

The exemplary method may further comprise the step of
transporting the storage container on the horizontal rail system using the second container handling vehicle such that the lifting device is aligned with a grid opening providing access to a storage column within the second storage volume or a grid opening providing access to a port column. An access station for further handling of the storage container may be arranged at a lower end of the port column.

### BRIEF DESCRIPTION OF THE DRAWINGS

The following drawings depict embodiments of the present invention by way of example only and are appended to facilitate the understanding of the invention.

FIG. 1 is a perspective view of a prior art automated storage and retrieval system comprising a rail system onto which a plurality of remotely operated container handling vehicles are operating and a storage volume for storing stacks of containers.

FIG. 2 is a perspective view of a prior art remotely operating vehicle having a centrally arranged cavity for carrying containers therein.

FIG. 3 is a perspective view of a prior art remotely operating vehicle having a cantilever for carrying containers underneath.

FIG. 4 is a perspective view of a prior art remotely operating vehicle having an internally arranged cavity for carrying containers therein, wherein the cavity is offset from its center relative to the X-direction.

FIG. 5 are side views of an exemplary automated storage and retrieval system according to an embodiment of the invention, comprising a rail system onto which a plurality of remotely operated container handling vehicles are operating and two wall separated storage volumes for storing stacks of containers, wherein FIG. 5A and FIG. 5B show a preferred arrangement of a container transfer apparatus, which allows access for container handling vehicles coming from an ambient space on one side of the container transfer apparatus or a chilled space on the other side of the container transfer apparatus, respectively.

FIG. 6 are side views of an exemplary automated storage and retrieval system according to a second embodiment of the invention, wherein FIG. 6A and FIG. 6B show the container transfer apparatus of FIG. 5 arranged within the ambient space.

FIG. 7 shows perspective views of a container transfer apparatus allowing access for container handling vehicles from an ambient space and/or a chilled space, while avoiding thermal leakage.

FIG. 8 is a perspective view of a container transfer apparatus according to one embodiment of the invention.

FIG. 9 is a perspective view of a container transfer apparatus according to another embodiment of the invention with a container handling vehicle arranged within the container transfer apparatus.

### DETAILED DESCRIPTION OF THE INVENTION

In the following, embodiments of the invention will be discussed in more detail by way of example only and with reference to the appended drawings. It should be understood, however, that the drawings are not intended to limit the invention to the subject-matter depicted in the drawings. Furthermore, even if some of the features are described in relation to the automated storage and retrieval system and the container transfer apparatus only, it is apparent that they are valid for the related methods as well, and vice versa.

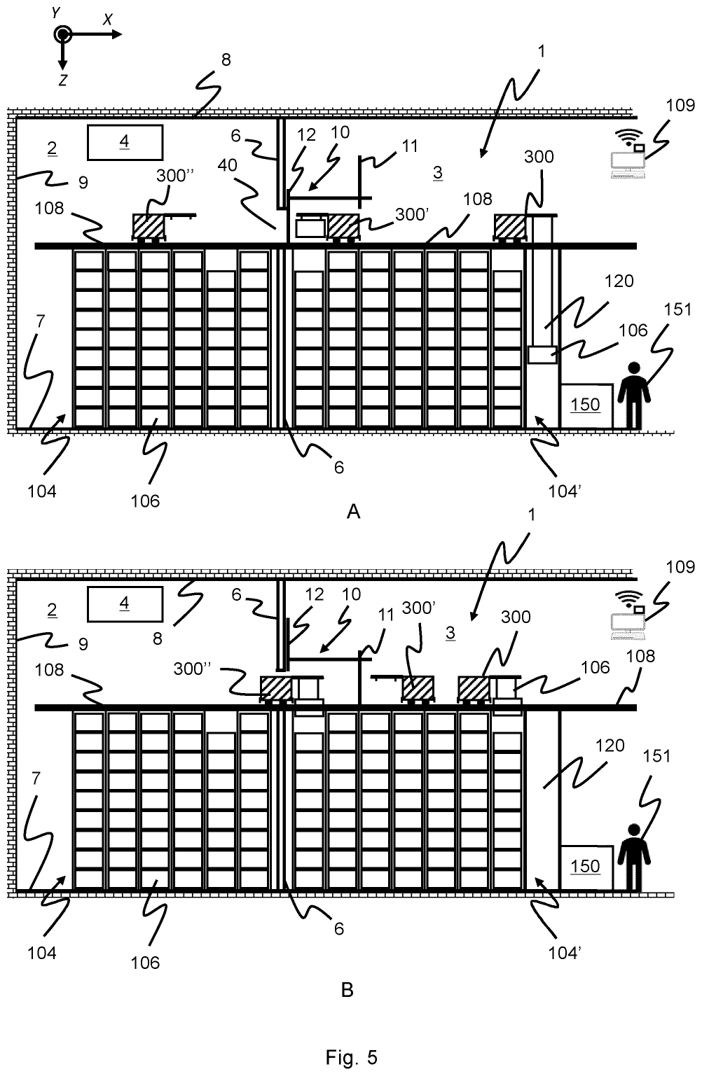

FIGS. 5A and 5B show a side view of an automated storage and retrieval system 1 according to a preferred embodiment of the invention. Positive X, Y- and Z-directions are directed from left to right of the drawing, out of the drawing and from top to bottom of the drawing, respectively.

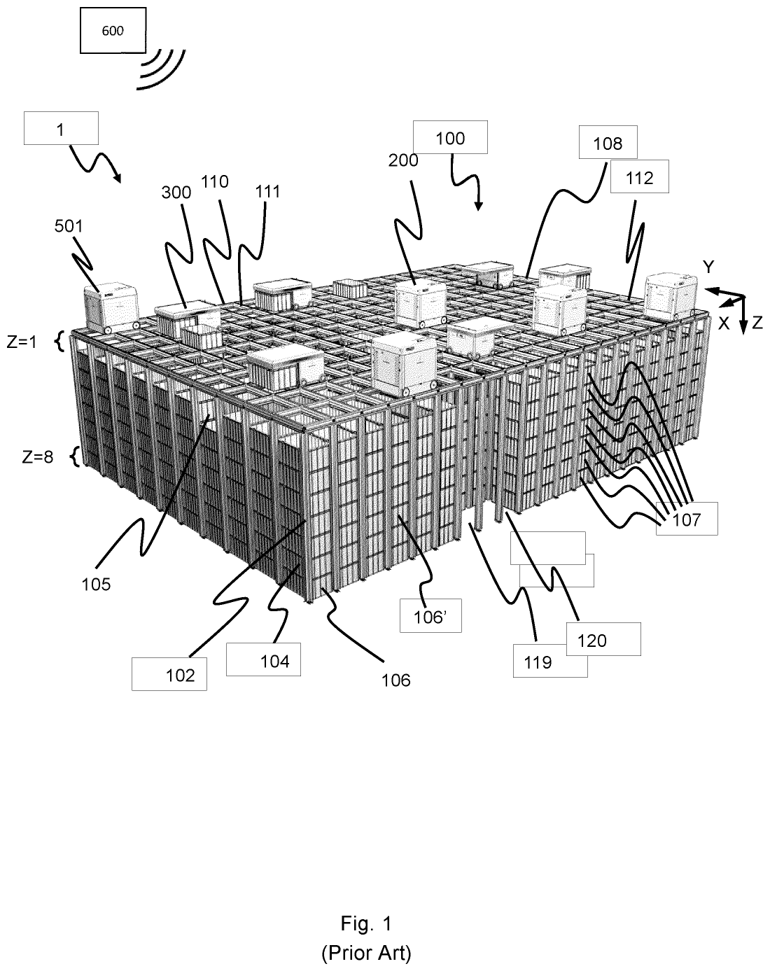

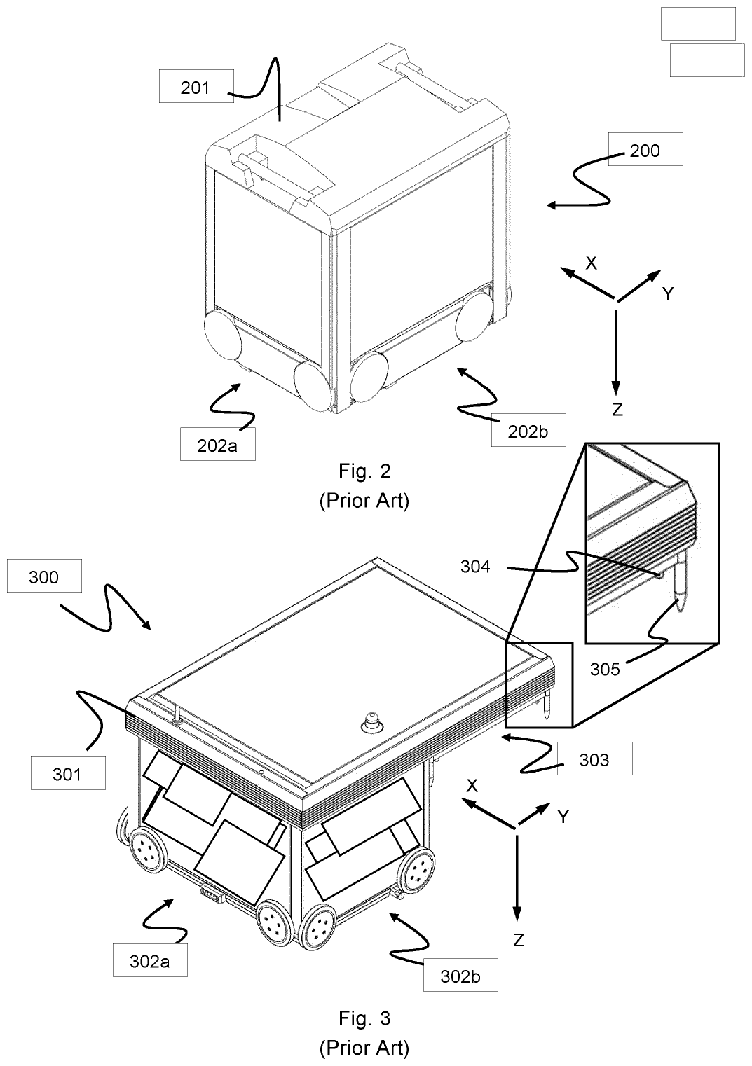

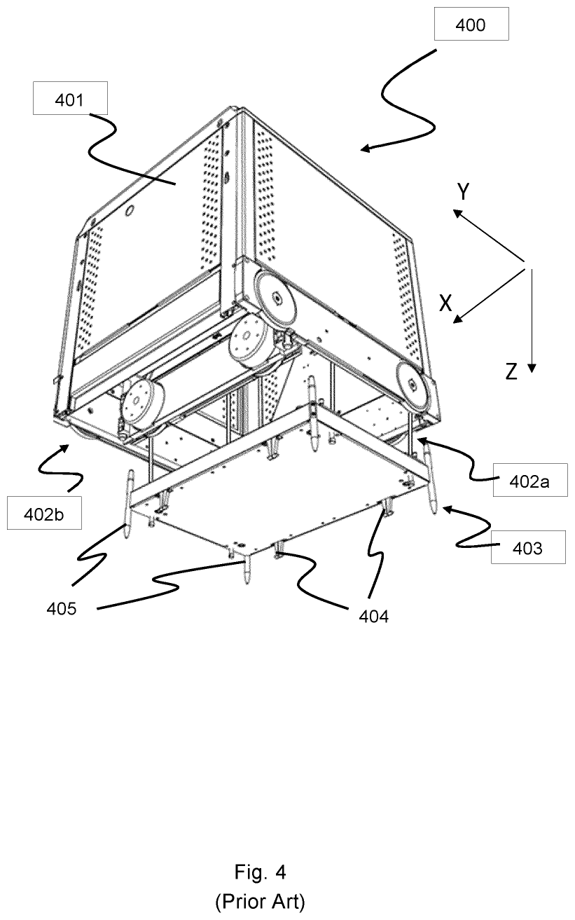

The storage system 1 is divided into a first space 2 and a second space 3 by a wall 6 aligned in the Y-Z plane. Both the first space 2 and the second space 3 contain a storage volume 104,104′ above a common floor 7, where each storage volume 104,104′ contains containers 106 stacked in vertical stacks 107. A rail system 108 as described in connection with the prior art system of FIG. 1 extends above both spaces 2,3. The part of the storage system 1 within the second space 3 also includes one or more port columns 120 for drop off or pick up of containers 106 to be transported to/from an access station 150. Further handling of containers 106 at the access station 150 may be performed by an operator 151. The stacks 107 may be vertically supported by upright members 103 within the volume 104,104′.

If the purpose is to maintain the first space 2 at a temperature different from the second space 3, the dividing wall 6 may comprise thermal insulating materials, such as expanded foam materials like polystyrene, fibrous materials like fiberglass and/or other materials or arrangements that provide a break or at least a reduction in thermal conduction between the ambient and chilled spaces as compared to conventional wall materials.

If the purpose is to prevent spread of fire from the first space 2 to the second space (or vice versa), the dividing wall 6 may comprise (in addition or alternatively to thermal insulating materials) fireproof material such as fire-resistant glass, concrete, gypsum, stucco and brick

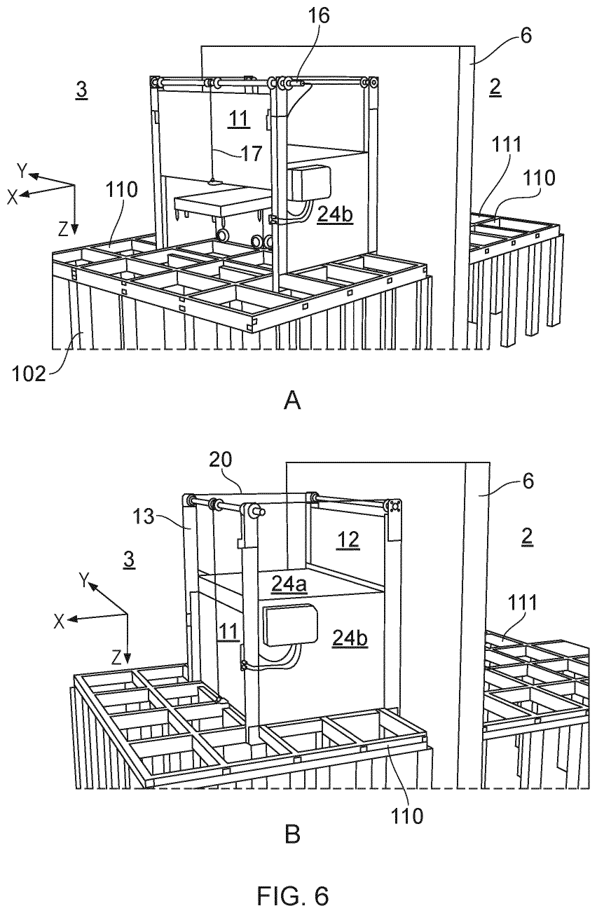

The storage system 1 also includes container handling vehicles 300 operating on top of the rail system 108 in both the first and the second space 2,3 and a container transfer apparatus 10 arranged adjacent one or more openings 40 going through the dividing wall 6. In FIG. 5 the container transfer apparatus 10 is shown within the first space 2. However, the container transfer apparatus 10 may alternatively be placed within the second space 3 (see FIG. 6) or partly within the first space 2 and the second space 3 (not shown), e.g., midway between.

The container transfer apparatus 10 is configured to allow one or more container handling vehicles 300 to pick-up and drop-off of containers 106 into stacks 107 located inside the container transfer apparatus 10 or within the storage volume 104,104′ directly below the container transfer apparatus 10 while reducing thermal and/or gaseous leakage between the first and second space 2,3.

In addition to the floor 7, the storage system 1 comprises a ceiling/roof 8, a second vertical wall 9 arranged oriented in the Y-Z plane opposite the dividing wall 6 within the first space 2, and two additional walls oriented in the X-Z plane at the front and back (not shown in FIG. 5), thereby enclosing the first space 2.

The opening 40 is arranged through the wall 6, immediately above the part of the rail system 108 and has a size in the Y-Z plane sufficiently large to allow the container handling vehicles 300 to move therethrough. Several such openings 40 may also be envisaged, for example several openings 40 associated with the same container transfer apparatus 10 and/or a plurality of container transfer apparatus 10 where each is associated with an opening 40.

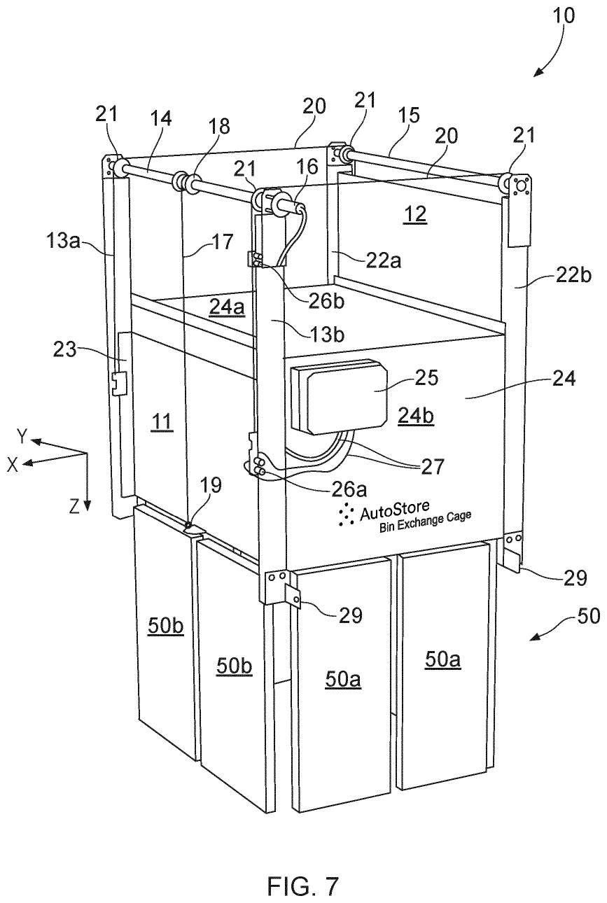

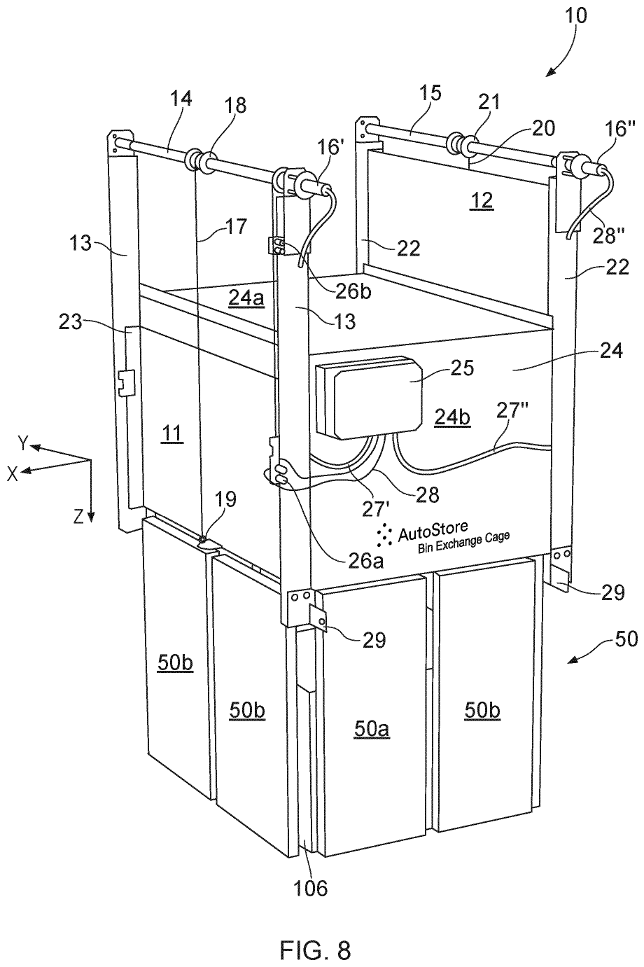

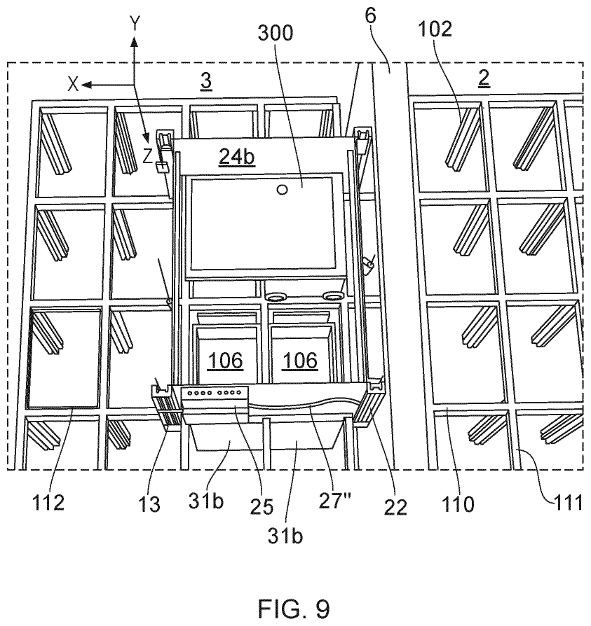

In order to allow separation between the two spaces 2,3, the container transfer apparatus 10 comprises a container transfer housing 24 having an openable access point at the two sides in the Y-Z plane (i.e. parallel to the wall 6) and two openable doors 11,12 configured to close the two openable access points of the housing 24. As best shown in FIGS. 7 and 8, the housing 24 comprises a housing roof 24a and two housing walls 24b oriented in the X-Z plane. The housing 24 is open towards the rail system 108 to allow storage containers 106 to be deposited within the storage columns 105 below the container transfer housing 24.

When the container transfer apparatus 10 is arranged adjacent the opening(s) 40, and at least one of the first door 11 and the second door 12 closes the respective access points of the housing 24, the first and second spaces 2,3 are isolated, thus at least reducing gaseous and/or thermal leakage there between and/or avoiding exposure of the container handling vehicles 300,300′,300″ to different temperature zones.

FIG. 7 shows in details a first embodiment of a container transfer apparatus 10 allowing said transfer of containers 106 between the first space 2 and the second space 3.

In order to allow controlled opening and closing of the access points of the container transfer housing 24, the first door 11 and the second door 12 may be guided in the vertical direction (i.e. Y-Z plane) along a first door frame 13 and a second door frame 22, respectively. Hence, the opening and closing is in this exemplary configuration obtained by lifting and lowering the transport doors 11,12 and is achieved by use of the door frames 13,22 in form of vertical bars 13a, 13b,22a,22b arranged at the peripheries of the open sides and having a length equal or exceeding two times the height of the opening into the open sides of the housing 24. Controlled vertical movements are thus achieved by guiding the doors 11,12 along tracks/recesses within each bar, for example by use of a guiding structure 23 on each side of the doors 11,12. The bars 13a, 13b,22a,22b may be of the same type as used as upright members 102 within the storage volume 104, 104′.

Still with particular reference to FIG. 8, a first drive shaft 14 and a second drive shaft 15 is arranged across the top ends of the bars 13a, 13b,22a,22b at the respective sides of the housing 24 with the port. A wire 17 (which will be referred to herein as a “master wire 17”) is at one end connected to a spool 18 arranged on the first drive shaft 14 at the other end to a fastening element 19 on the first door 11. Moreover, a drive shaft motor 16 is arranged on an end of the first drive shaft 14 allowing controlled rotation. The opening and closing of the port into the housing 24 distal to the wall 6 is thus achieved by rotating the first drive shaft 14 in a clockwise and counterclockwise direction, respectively, while winding/unwinding the master wire 17 onto/from the spool 18.

In order to allow opening and closing of the second door 12 using the drive shaft motor 16, the container transfer apparatus 10 of the first embodiment also comprises two wires 20 (which will be referred to herein as “slave wires 20”), where each slave wire 20 has one end fixed to the first door 11 and the other end fixed to the second door 12 and where each slave wire 20 is coupled to both the first and the second drive shafts 14,15 via pulleys 21. These pulleys 21 may be connected at the ends of each drive shafts 14,15. If only one slave wire 20 is used for the opening/closing of the second door 12, the position may preferably be arranged closer to the middle of the drive shafts 14,15 to allow uniform guidance along the bars 13a, 13b,22a,22b during lifting/lowering.

The container transfer apparatus 10 may also comprise a controller 25 providing and/or distributing power to the drive shaft motors 16,16′ via a power cable 27. The controller 25 may also provide signal communication with a sensor system 26 such as a position sensor system providing information concerning the position of the first door 11, and thereby also the position of the second door 12. The signal communication between the controller 25 and the sensory system 26 may be achieved through signal line(s) 28 or wireless communication. The controller 25 may further be configured to allow wireless communication with the control system 109 of the automated storage and retrieval system 1.

FIG. 8 shows an example of a position sensor system 26 comprising a lower position sensor 26a and an upper position sensor 26b, both connected to the signal line(s) 28.

The container transfer apparatus 10 may be removable fixed to the rail system 108 via brackets 29 arranged at the lower end on each bar 13a, 13b,22a,22b.

The FIGS. 5-9 show a container transfer apparatus 10 having a container transfer housing 24 of size corresponding to 2×2 grid openings 112 plus two rail track widths. However, any size allowing picking up and dropping of containers 106 within the housing 24 may be envisaged.

In order to further lower the risk of thermal leakage between the first and the second spaces 2,3 during transfer of containers 106, the container transfer apparatus 10 may also comprise a thermal insulating skirt 50 fixed or suspended from underneath the container transfer housing 24. The skirt 50 may be of any length, but may preferably extend the entire length to the common floor 7 (or at least to a lowest point of a storage column 105) to ensure maximum thermal insulation. In FIGS. 7-9 the skirt 50 is attached to the container transfer housing 24 by brackets fixed to the first and second door frames 13,22.

FIGS. 7 and 8 show an example of a thermal insulating skirt 50 for a 2×2 grid opening-sized container transfer housing 24. The skirt 50 comprises eight plates 50a,50b extending from a base of the housing 24, where four X plates 50a are extended into the storage volume 104′ with their faces oriented along two parallel rails 110 in the X direction (i.e. two plates 50a arranged at the outer side of each rail 110, where each of the two plates 50a are inserted into separate storage columns 105) and four Y plates 50b are extended into the storage volume 104′ with their faces oriented along two parallel rails 111 in the Y direction (i.e. two Y plates 50b at the outer side of each rail 111 in the same manner as for the X plates 50a). The width of each X plate 50a and the width of each Y plate 50b is equal to or slightly less than the width of the respective grid opening 112 in the X direction and the Y direction respectively. The length of each X plate 50a and Y plate 50b shall be at least a length corresponding to the distance between the base of the container transfer housing 24 and the first layer below the rail system 108. However, to achieve maximum thermal insulation between the first space 2 and the second space 3, the X and Y plates 50a,50b should preferably extend a plurality of layers below the rail system 108 and more preferably to the floor 7 (or provided in segments thereof).

FIG. 9 shows a second embodiment of a container transfer apparatus 10 allowing transfer of containers 106 between the first space 2 and the second space 3.

The container transfer apparatus 10 of the second embodiment is configured in the same way as the container transfer apparatus 10 of the first embodiment with the exception that controlled opening and closing of the open sides of the container transfer housing 24 is achieved by use of a first drive shaft motor 16′ and a second drive shaft motor 16″ enabling controlled rotation of respective first drive shaft 14 and second drive shaft 15. Hence, the first door 11 and the second door 12 may be guided in the vertical direction (i.e. Y-Z plane) along the first door frame 13 and the second door frame 22, respectively, by arranging a first wire spool 18 to the first drive shaft 14 and a second wire spool 21 onto the second drive shaft 15, and further attaching a first wire 17 between the first wire spool 18 and the first door 11 and attaching a second wire 18 between the second wire spool 21 and the second door 12.

Controlled vertical moments are thus achieved by operating the first drive shaft motor 16′ and the second drive shaft motor 16″ independently.

FIG. 9 shows a part of the inventive storage system 1 with a dividing wall 6 separating the system 1 into a first space 2 and a second space 3 and a container transfer apparatus 10 as described above. In order to show the inner volume of the container transfer apparatus 10, the top part and any thermal insulation of the top part has been removed, including the housing roof 24a, the drive shafts 14,15 and the drive shaft motors 16′,16″. As seen in FIG. 9, the size of the container transfer housing 24 is in this exemplary configuration 2×2 grid openings 112, thereby allowing the entire container handling vehicle 300 with cantilever to enter the housing's inner volume. However, the size of the container transfer housing 24 may be of any size n×m, where n and m are integers corresponding to the number of storage columns 105 or grid openings 112.

In a similar way as for the dividing wall 6, the container transfer housing 24 may comprise thermal insulating materials such as expanded foam materials like polystyrene, fibrous materials like fiberglass if the intention of the storage system 1 is to maintain the first space 2 and the second space 3 at different temperatures. Alternatively, or in addition, the container transfer housing 24 may include fire-proof materials such as fire-resistant glass, concrete, gypsum, stucco and brick.

When the intention of the system 1 is to maintain a temperature within the first space 2 different from the temperature within the second space 3, for example, that the first space 2 is a chilled space and the second space 3 is an ambient space, the container transfer apparatus 10 may also comprise temperature sensors, where at least one temperature sensor is arranged on the side of the container transfer housing 24 facing the opening 40 and at least one other temperature sensor is arranged somewhere within the space 2,3 opposite the space 2,3 with the housing 24, thereby allowing real-time monitoring of the temperature difference within the first and second spaces 2,3 during operation. This again would allow swift detection of undesired temperature equalization during container transfer, for example due to damaged seals.

Again with particular reference to FIG. 5, an example sequence to transport a container 106 from the first space 2 (for example, a chilled space at a temperature below 5° C.) to the second space 3 (for example, an ambient space at room temperature) may proceed as follows:
(FIG. 5A) The first door 11 opens towards the first space 2 by operating the drive shaft motor 16,16′ connected to the first drive shaft 14.
   If the first embodiment container transfer apparatus 10 is used, the operation of the drive shaft motor 16,16′ causes the second door 12 to close using a slave wire 20 as described above, thereby covering the opening 40 towards the second space 3.
   If the second embodiment container transfer apparatus 10 is used, the second door 12 is closed by operating a second drive shaft motor 16″. The opening of the first door 11 is preferably performed when the second door 12 is closed to minimize thermal and/or gaseous leakage during operation.
(FIG. 5A) A first container handling vehicle 300″ operable on the rail system 108 within the first space 2 picks up a container 106 from within the first storage volume 104 and transports the container 106 into the container transfer housing 24 via the first access point.
(FIG. 5A) The first container handling vehicle 300″ aligns the container 106 to one of the storage columns 105 covered by the container transfer housing 24, lowers the container 106 through the grid opening 112 of the rail system 108 by operating the lifting device 303 and places the container 106 in a space on top of the stack in an uppermost container position in the stack 107. If no other containers are present in the storage column 105, the container 106 is placed on the floor 7 (or a lowest point of the storage column 105 if the storage volume 104 is raised off the floor 7 of the building).
(FIG. 5A) The first container handling vehicle 300″ releases the container 106 and retracts the lifting device 303, and moves out of the container transfer housing 24.
(FIG. 5B) the first door 11 closes by operating the drive shaft motor 16,16′.
   If the first embodiment container transfer apparatus 10 is used, the second door 12 towards the opening 40 into the second space 3 is as a result opened.
   If the second embodiment container transfer apparatus 10 is used, the second door 12 is opened by operating the second drive shaft motor 16″. The opening of the second door 12 is preferably performed after the first door 11 is closed to minimize thermal and/or gaseous leakage during operation.
(FIG. 5B) A second container handling vehicle 300′ within the second space 3 moves into the container transfer housing 24 via the opening 40 of the wall 6 such that its lifting device 303 is aligned with the grid opening 112 and the container 106 placed by the first container handling vehicle 300″ described above.
(FIG. 5B) The second container handling vehicle 300′ lifts the container 106 above the rail system 108 by use of the lifting device 303 and moves out of the container transfer housing 24 and fully into the second space 3. The second container handling vehicle 300′ may then place the container 106 in a second column of the second storage space 104′ for further storage or transport the container 106 to the access station 150 via the port column 120.

FIGS. 6A and 6B shows a similar container transfer operation as shown in FIGS. 5A and 5B, but with the container transfer apparatus 10 arranged fully within the second space 3.

A container transfer operation of transferring a storage container 106 in the opposite direction from the second space 3 to the first space 2 may thus proceed as follows:
(FIG. 6A) The first door 11 opens towards the second space 3 by operating the drive shaft motor 16,16′ connected to the first drive shaft 14.
   If the first embodiment container transfer apparatus 10 is used, the operation of the drive shaft motor 16,16′ causes the second door 12 to close using a slave wire 20 as described above, thereby covering the opening 40 into the first space 2.
   If the second embodiment container transfer apparatus 10 is used, the second door 12 is closed by operating a second drive shaft motor 16″. The opening of the first door 11 is preferably performed while the second door 12 is closed to minimize thermal and/or gaseous leakage during operation.
(FIG. 6A) A second container handling vehicle 300′ operable on the rail system 108 within the second space 3 picks up a container 106, either from the access station 150 or from within the second storage volume 104′, and transports the container 106 into the container transfer housing 24 via the first access point.
(FIG. 6A) The second container handling vehicle 300′ aligns the container 106 to one of the storage columns 105 covered by the container transfer housing 24, lowers the container 106 through the grid opening 112 of the rail system 108 by operating the lifting device 303 and places the container 106 in a space on top of the stack in an uppermost container position in the stack 107. If no other containers are present in the storage column 105, the container 106 is placed on the floor 7 (or a lowest point of the storage column 105 if the storage volume 104 is raised off the floor 7 of the building).
(FIG. 6A) The second container handling vehicle 300′ retracts the lifting device 303 and moves out of the container transfer housing 24.
(FIG. 6B) The first door 11 closes by operating the drive shaft motor 16,16′.
   If the first embodiment container transfer apparatus 10 is used, the second door 12 towards the opening 40 is as a result opened.
   If the second embodiment container transfer apparatus 10 is used, the second door 12 is opened by operating the second drive shaft motor 16″. The opening of the second door 12 is preferably performed after the first door 11 is closed to minimize thermal and/or gaseous leakage during operation.
(FIG. 6B) A first container handling vehicle 300″ within the first space 2 moves into the container transfer housing 24 via the opening 40 of the wall 6 such that its lifting device 303 is aligned with the grid opening 112 and the container 106 placed by the second container handling vehicle 300′ described above.
(FIG. 6B) The first container handling vehicle 300″ lifts the container 106 above the rail system 108 by use of the lifting device 303 and moves out of the container transfer housing 24 and fully into the first space 2.

FIGS. 5 and 6 also show a third container handling vehicle 300 receiving a container 106 from the access station 150 (FIGS. 5A and 6A) and places the container 106 on top of a stack 107 adjacent the pick-up column 120 (FIGS. 5B and 6B).

In order to at least reduce the risk of fire within the first space 2, the system 1 may be equipped with a gas regulating device (not shown). The gas regulating device may comprise a gas container located outside the first space 2, a gas inlet going into the first space 2 and a gas tube in fluid communication between the gas container and the gas inlet for adjusting the gas content in the atmosphere within the first space 2. With this arrangement, gas is allowed to flow between the gas container and the first space 2.

The gas container may comprise means for reducing a percentage of a gas element in a gas mixture, such as O₂ gas in air. Such means are known in the art and will thus not be explained further herein.

In dry air, the concentration of the flammable gas oxygen is about 21%. If the oxygen concentration is lowered to 16% or below, the risk of fire is significantly reduced. In air, a fire may potentially occur in theory, for example, due to sparks from the movements of the container handling vehicles 300 and/or sparks from the charging stations (not shown) for charging the batteries within the vehicles 300 and/or combustion of contents within containers 106 and/or accidental heating such as may be caused by sunlight hitting flammable material within the storage system 1.

The substantially gas-tight separation between the first space 2 and the second space 3 ensures that the container handling vehicles 300 may store and fetch containers 106 located within an oxygen reduced atmosphere that has a reduced or insignificant risk of fire, but which may represent a health risk for humans, and to receive and deliver containers 106 to a workspace in which humans may safely work.

Another example of a range of use for a storage system 1 allowing control of gas concentration is storage of fresh food. Prior art tests have shown that that fruits such as apples may be best long-term stored in an atmosphere comprising 1% O₂ and 1-2.5% CO₂. The O₂ gas in ambient air may be substantially replaced with N₂ gas.

A storage system 1 having both a cooling facility for cooling the first space 2 to temperatures below 10° C. and a gas regulating device, may create near ideal condition for storage of fresh food.

This fresh food configuration of the storage facility may be supplemented by a fire extinguishing device to decrease fire hazards.

In addition to the advantages mentioned above, the inventive storage system 1 facilitates installation and maintenance since the entire container transfer apparatus 10 or separate components of the container transfer apparatus 10 may be easily replaced. The solution is also cost efficient since the installation requires no or little rebuild of an existing storage system 1. As mentioned above, part of the door frames 13,22 may use the same type of bars/struts as used for the upright members 102 of the storage volume 104.

Mechanical stoppers may be provided on or at the rail system 108 within the inner volume of the container transfer housing 24 to prevent the container handling vehicle 300 to collide with the doors 11,12.

In the preceding description, various aspects of the automated storage and retrieval system and the container transfer apparatus according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMERALS/LETTERS

1 Automated storage and retrieval system
2 First space/chilled space
3 Second space/ambient space
4 Cooling system/refrigerator
6 Dividing wall/wall
7 Floor
8 Roof
9 External wall/second wall
10 Container transfer apparatus
11 First door
12 Second door
13 First door frame
14 First drive shaft
15 Second drive shaft
16 Drive shaft motor
16′ First drive shaft motor
16″ Second drive shaft motor
17 First wire/master wire
18 First wire spool/spool
19 Fastening element/master wire fastening element
20 Second wire/slave wire
21 Second wire spool
22 Second door frame
23 Guiding structure
24 Container transfer housing/container transfer housing
24a Housing roof
24b Housing wall
25 Controller
26 Position sensor system
26a First position sensor
26b Second position sensor
27 Power cable/first power cable
28 Signal line
29 Bracket
40 Wall opening
50 Thermal isolation skirt
50a X plates
50b Y plates
40 Wall opening/opening
100 Framework structure
102 Upright members of storage volume
103 Horizontal members of storage volume
104 First storage volume
104′ Second storage volume
105 Storage column
106 Container/storage container/container
106′ Particular position of a container/target container/target container
106″ Vacant storage space for a container/container
107 Stack
108 Rail system
109 Control system
110 Parallel rails in first direction (X)
111 Parallel rail in second direction (Y)
112 Grid opening
119 First port column/drop-off column
120 Second port column/pick-up column
150 Access station
151 Operator
200 Prior art container handling device/remotely operated vehicle with central cavity
201 Handling device body/Vehicle body
202a Drive means in first direction (X)
202b Drive means in second direction (Y)
300 Prior art container handling vehicle/remotely operated vehicle with cantilever/container handling vehicle
301 Handling device body/Vehicle body
302a Drive means/wheel arrangement, first direction (X)
303b Drive means/wheel arrangement, second direction (Y)
303 Lifting device
304 Gripper element
305 Guiding pin
400 Prior art container handling device/remotely operated vehicle with offset cavity
401 Handling device body/Vehicle body
402a Drive means/wheel arrangement, first direction (X)
402b Drive means/wheel arrangement, second direction (Y)
403 Lifting device
404 Gripper element
405 Guiding pin
X First direction
Y Second direction
Z Third direction

1. An automated storage and retrieval system comprising:
a first space and a second space;
a first storage volume within the first space to store storage containers in vertical stacks;
a horizontal rail system arranged above where the storage containers are stored or would be stored, wherein the horizontal rail system comprises a first set of rails and a second set of rails oriented perpendicular to the first set of rails, intersections of the first set of rails and the second set of rails form a grid of grid cells defining grid openings;
a first container handling vehicle configured to lift a storage container through one of the grid openings and to transport the storage container along the horizontal rail system;
a wall separating the first space from the second space, wherein the wall comprises an opening having a size allowing the storage containers to pass through the wall; and
a container transfer housing configured to provide a passage to allow transfer of the storage containers between the first space and the second space.

2. The automated storage and retrieval system according to claim 1, wherein the container transfer housing comprises
a first door configured to open and close a first access point of the container transfer housing and
a second door configured to open and close a second access point of the container transfer housing
and wherein the automated storage and retrieval system comprises
a door mechanism configured to operate the first door and/or the second door such that one door is closed when the other door is opened, and
wherein the container transfer housing is designed and positioned such that, when one of the first door and the second door is closed, the opening is also closed.

3. The automated storage and retrieval system according to claim 2, wherein the second door is positioned to simultaneously open and close one side of the opening.

4. The automated storage and retrieval system according claim 3, wherein the door mechanism comprises
a drive shaft motor configured to lift the first door relative to the first access point.

5. The automated storage and retrieval system according claim 4, wherein the door mechanism comprises
a first drive shaft and
a first wire connecting the first drive shaft to the first door wherein the drive shaft motor is configured to rotate the first drive shaft.

6. The automated storage and retrieval system according to claim 5, wherein the first drive shaft, the first wire and the drive shaft motor are configured such that,
when the drive shaft motor is rotating the first drive shaft in one rotational direction, the first door is lowered to close the first access point and
when the drive shaft motor is rotating the first drive shaft in an opposite rotational direction, the first door is raised to open the first access point.

7. The automated storage and retrieval system according to claim 2, wherein the door mechanism comprises
a second drive shaft motor configured to lift the second door relative to the second access point.

8. The automated storage and retrieval system according to claim 7, wherein the door mechanism comprises
a second drive shaft and
a second wire connecting the second drive shaft to the second door such that, when the second drive shaft motor is rotating the second drive shaft in one direction, the second door is lifted relative to the second access point and when the second drive shaft motor is rotating the second drive shaft in the other direction, the second door is lowered relative to the second access point.

9. The automated storage and retrieval system according to claim 8, wherein
the second drive shaft, the second wire and the second drive shaft motor are configured such that,
when the second drive shaft motor is rotating the second drive shaft in one rotational direction, the second door is lowered to close the second access point and
when the second drive shaft motor is rotating the second drive shaft in an opposite rotational direction the second door is raised to open the second access point.

10. The automated storage and retrieval system according to claim 1, wherein the automated storage and retrieval system comprises
a container transporting device arranged in the second space, wherein the container transporting device is configured to transport a storage container from inside the container transfer housing to another location in the second space.

11. The automated storage and retrieval system according to claim 1, wherein the storage and retrieval system comprises
a second storage volume contained within the second space to store storage containers in vertical stacks.

12. The automated storage and retrieval system according to claim 11,
wherein the horizontal rail system extends through the opening and above the second storage volume such that a height from a top part of the rail system to a top part of the opening is equal or higher than a height of the storage containers to be stored.

13. The automated storage and retrieval system according to claim 10,
wherein the container transporting device is a second container handling vehicle configured to transport a storage container from the container transfer housing along the horizontal rail system.

14. The automated storage and retrieval system according to claim 1,
wherein the container transfer housing displays an open bottom face and
wherein the automated storage and retrieval system comprises a skirt arranged below the container transfer housing and extending around at least partly the open bottom face.

15. A container transfer apparatus for transfer of storage containers between a first space having a first temperature and a second space having a second temperature different from the first temperature, wherein the container transfer apparatus comprises:
a container transfer housing comprising
a first door configured to open and close a first access point of the container transfer housing;
a second door configured to open and close a second access point of the container transfer housing; and
a door mechanism configured to operate the first door and/or the second door such that one door is closed when the other door is opened; and
a skirt mountable below the container transfer housing, wherein the skirt is configured such that thermal conduction across the skirt is reduced.

16. The container transfer apparatus according to claim 15,
wherein the container transfer housing and the skirt defines an inner volume and
wherein at least part of the container transfer apparatus is provided with thermal insulating material to reduce thermal conduction from the inner volume to surroundings.

17. A method for transferring storage containers between a first space and a second space within an automated storage and retrieval system according to claim 1,
wherein the method comprises the steps of:
placing a storage container within the container transfer housing using a first container handling vehicle; and
removing the storage container from the container transfer housing using a lifting device constituting part of a container transporting device.
